(19) United States
(12) Patent Application Publication
(10) Pub. No.: US 2008/0200306 A1
(43) Pub. Date: Aug. 21, 2008

(54) Gear Mechanism for a Brake System, and Brake System

(76) Inventor: Jurgen Sturzer, Aiterhofen (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/996,602

(22) PCT Filed: Jun. 19, 2006
(86) PCT No.: PCT/EP06/63313

§ 371 Date: Jan. 24, 2008

(30) Foreign Application Priority Data
Jul. 27, 2005 (EP) 05016333.6

(51) Int. Cl. B60T 13/74; B60T 13/02

(52) U.S. Cl. 477/193; 188/162

(57) ABSTRACT

A gear mechanism for a brake system can be coupled on the inlet side to an actuating drive of the brake system via a drive shaft which can be driven rotationally by the actuating drive. The gear mechanism can be coupled on the output side to a brake unit of the brake system via an output shaft. The brake unit has at least one brake. The gear mechanism has a first and a second gear train having different transmission ratios. Furthermore, the gear mechanism is configured in such a way that, in order to apply the brake, only the first gear train and, in order to release the brake, only the second gear train of the gear mechanism transmits a drive torque of the actuating drive to the output shaft. The transmission ratio of the second gear train is greater than the transmission ratio of the first gear train.

### CROSS-REFERENCE TO RELATED APPLICATIONS

This application is a U.S. national stage application of International Application No. PCT/EP2006/063313 filed Jun. 19, 2006, which designates the United States of America, and claims priority to European application number 05016333.6 filed Jul. 27, 2005, the contents of which are hereby incorporated by reference in their entirety.

### TECHNICAL FIELD

The invention relates to a gear mechanism for a brake system, and a brake system, in particular an electrically controllable brake system, e.g. a parking brake system in a motor vehicle.

### BACKGROUND

High demands are made on brake systems, particularly brake systems in motor vehicles, with regard to safety and reliability.

### SUMMARY

There exists a need for a gear mechanism and a brake system that enable reliable and safe braking.

According to an embodiment, a gear mechanism for a brake system, may comprise a gear mechanism which can be coupled on the inlet side to an actuating drive of the brake system by way of a drive shaft and the drive shaft can be driven rotationally by the actuating drive and the gear mechanism can be coupled on the output side to a brake unit of the brake system by way of an output shaft and the brake unit comprises at least one brake or the gear mechanism comprises the drive shaft and/or the output shaft, the gear mechanism comprises a first and second gear train with different transmission ratios and the gear mechanism is configured is such a way that, in order to apply the brake, only the first gear train and, in order to release the brake, only the second gear train of the gear mechanism transmits a drive torque of the actuating drive to the output shaft and the transmission ratio of the second gear train is greater than the transmission ratio of the first gear train.

According to a further embodiment, the gear mechanism may be configured such that either the first gear train or the second gear train is selected depending on the direction of rotation of the drive shaft. According to a further embodiment, the gear mechanism may comprise a coupling unit that is arranged such that it can be moved into a first and into a second position area and the drive shaft may be coupled to the output shaft by the coupling unit in the first and in the second position areas in such a way that coupling in the first position area forms the first gear train and coupling in the second position area forms the second gear train. According to a further embodiment, a longitudinal toothing may be provided in the drive shaft or the output shaft, and the coupling element may be arranged so that it can be moved axially on the drive shaft or the output shaft into the first position area or the second position area, in such a way that the coupling element is rotationally coupled to the drive shaft or the output shaft by the longitudinal toothing. According to a further embodiment, a helical groove may be provided in the drive shaft, and the coupling unit may have a lug, and the coupling unit may be arranged so that it can be moved axially on the drive shaft in such a way that the lug engages in the groove, and the coupling unit is moved axially by the rotation of the drive shaft into the first position area or into the second position area depending on the direction of rotation. According to a further embodiment, the coupling unit may comprise at least one gear wheel or dog for the first gear train and the second gear train in each instance, which engages with a further gear wheel or dog that is assigned to the respective gear train in the first position area or in the second position area in order to transfer the drive torque.

According to another embodiment, a brake system may comprise a drive unit and a brake unit with at least one brake, the drive unit comprising an actuating drive, a drive shaft which is coupled to the actuating drive and by which it can be rotationally moved, an output shaft that is coupled to the brake unit in such a way that the brake unit applies or releases the brake depending on the direction of rotation of the output shaft, a gear mechanism which is coupled on an inlet side to the drive shaft and on an outlet side to the output shaft or which comprises the drive shaft and/or the output shaft wherein the gear mechanism comprises a first and second gear train with different transmission ratios and the gear mechanism is configured is such a way that, in order to apply the brake, only the first gear train and, in order to release the brake, only the second gear train of the gear mechanism transmits a drive torque of the actuating drive to the output shaft and the transmission ratio of the second gear train is greater than the transmission ratio of the first gear train.

### BRIEF DESCRIPTION OF THE DRAWINGS

Exemplary embodiments of the invention are described below with reference to the schematic drawings, in which;

FIG. 1 shows a brake system,

FIG. 2 shows a first embodiment of a gear mechanism for the brake system, and

FIG. 3 shows a second embodiment of the gear mechanism for the brake system.

Elements with the same construction or function have the same reference numeral in all figures.

### DETAILED DESCRIPTION

According to a first aspect, a gear mechanism for a brake system, in which the gear mechanism can be coupled on the inlet side to an actuating drive of the brake system via a drive shaft and the drive shaft can be driven rotationally by the actuating drive. The gear mechanism can be coupled on the output side to a brake unit of the brake system via an output shaft. The brake unit comprises at least one brake. The gear mechanism can also comprise the drive shaft and/or the output shaft. The gear mechanism comprises a first and second gear train having different transmission ratios. Furthermore, the gear mechanism is configured in such a way that, in order to apply the brake, only the first gear train and, in order to release the brake, only the second gear train of the gear mechanism transmits a drive torque of the actuating drive to the output shaft. The transmission ratio of the second gear train is greater than the transmission ratio of the first gear train.

The advantage is that different transmission ratios can be selected for applying and for releasing the brake. Thus, the brake can be applied very forcefully by the low transmission ratio and the brake can be released very quickly by the high transmission ratio. In particular, the brake can be released very quickly in this way if, for example, a wheel is locked by the applied brake. An anti-lock braking system can thus be realized for example by appropriate control of the actuating drive. Furthermore, a dynamic emergency braking function can thus be provided for a parking brake system in a motor vehicle for example, which enables the electrically controlled braking to be executed reliably and safely, e.g. if an available hydraulic brake system should fail.

According to an embodiment, the gear mechanism is configured such that either the first gear train or the second gear train is selected depending on the direction of rotation of the drive shaft. This has the advantage that the direction of rotation of the drive shaft can be very easily changed by an appropriate control of the actuating drive. This means that a further actuating drive for switching the gear mechanism from the first gear train to the second gear train or from the second gear train to the first gear train may not be necessary. A brake system equipped with this type of gear mechanism can thus be realized very easily and in a cost-effective manner.

According to a further embodiment, the gear mechanism comprises a coupling unit that is arranged such that it can be moved in a first and in a second position area. The drive shaft is coupled to the output shaft by way of the coupling unit in the first and second position area such that coupling in the first position area forms the first gear train and coupling in the second position area forms the second gear train. The advantage is that a gear mechanism of this type can be realized very easily and in a cost-effective manner.

In this context, it is advantageous if longitudinal toothing is provided in the drive shaft or the output shaft and the coupling element is arranged so that it can be moved axially into the first position area or the second position area on the drive shaft or the output shaft. The coupling element is rotationally coupled to the drive shaft or the output shaft by the longitudinal toothing. This is advantageous in that the coupling element can be moved axially on the drive shaft or output shaft very easily and only a small installation space is required.

According to a further embodiment, a helical groove is provided in the drive shaft of the gear mechanism. The coupling unit has a lug and is arranged so that it can be moved axially on the drive shaft such that the lug engages in the groove and the coupling unit is moved axially by the rotation of the drive shaft into the first position area or into the second position area depending on the direction of rotation. This has the advantage that no additional actuating drive is required for the axial movement of the coupling unit. Furthermore, the arrangement of the coupling unit on the drive shaft only requires a small installation space.

According to a further embodiment, the coupling unit comprises at least one gear wheel or dog for the first gear train and the second gear train in each instance, which engages in the first position area or in the second position area with a further gear wheel or with a further dog assigned to the respective gear train in order to transfer the drive torque. This has the advantage that the different transmission ratios of the first gear train and the second gear train can be very easily realized by appropriate configuration of the gear wheels. Furthermore, the gear mechanism can thus be constructed particularly compactly.

According to a second aspect, a brake system comprises a drive unit and a brake unit with at least one brake. The drive unit comprises an actuating drive, a drive shaft, an output shaft and the gear mechanism. The drive shaft is coupled to the actuating drive by which it can be driven rotationally. The output shaft is coupled to the brake unit in such a way that the brake unit applies or releases the brake depending on the direction of rotation of the output shaft. The gear mechanism is coupled to the drive shaft on the inlet side and to the output shaft on the outlet side or comprises the drive shaft and/or the output shaft. The advantages of this brake system result accordingly from the advantages of the gear mechanism.

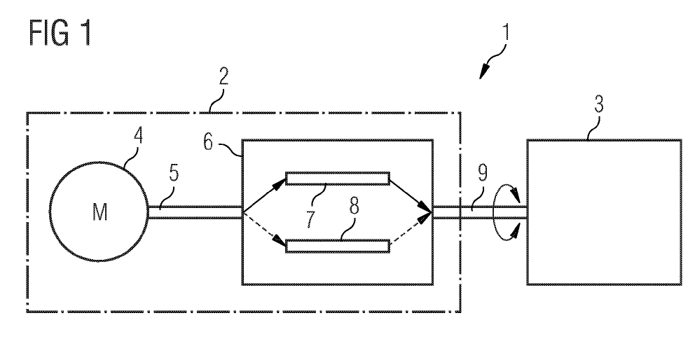

A brake system 1, e.g. an electrically controllable parking brake system in a motor vehicle, comprises a drive unit 2 and a brake unit 3 (FIG. 1). The drive unit 2 comprises an actuating drive 4 and a gear mechanism 6, which is coupled to the actuating drive 4 by way of a drive shaft 5. The gear mechanism 6 has a first gear train 7 and a second gear train 8, each of which is assigned a transmission ratio. The gear mechanism 6 is coupled to the brake unit 3 by way of an output shaft 9. The transmission ratio is defined in each instance as the ratio of a rotation of the output shaft 9 to a rotation of the drive shaft 5.

The brake system 1 is configured such that a drive torque from the actuating drive 4 is transferred via the drive shaft 5, the first gear train 7 and the output shaft 9 to the brake unit 3, and the drive torque from the actuating drive 4 is transferred via the drive shaft 5, the second gear train 8 and the output shaft 9 to the brake unit 3 to release the brake. The brake is applied or released depending on the direction of rotation of the output shaft 9. The transmission ratio that is allocated to the second gear train 8 is greater than the transmission ratio that is allocated to the first gear train 7. Thus, the brake can be applied very forcefully and released very quickly depending on the transmission ratio selected in each instance.

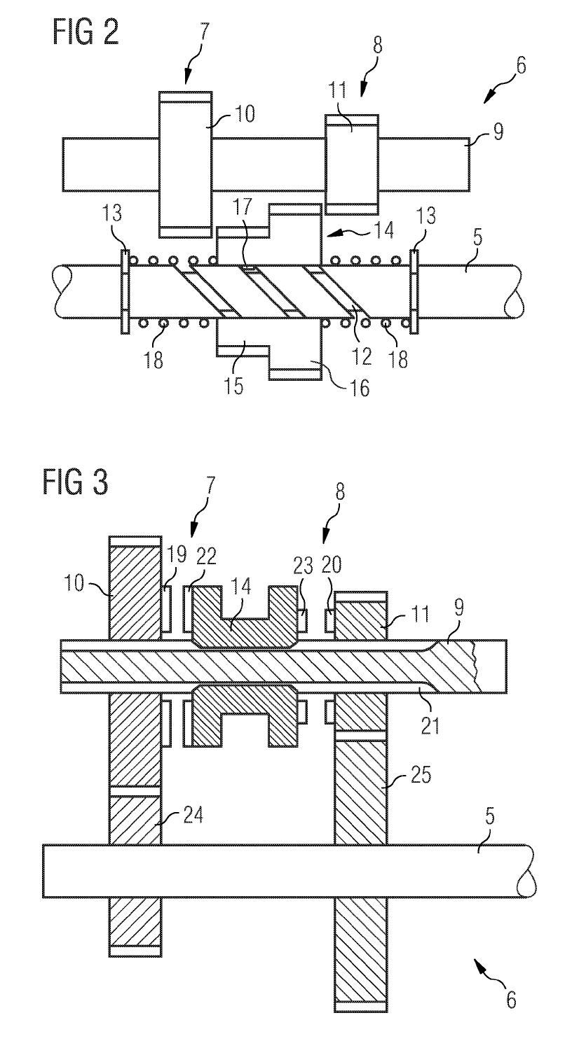

FIG. 2 shows a first embodiment of the gear mechanism 6. The drive shaft 5 and the output shaft 9 are arranged parallel to each other. A first gear wheel 10 and a second gear wheel 11 are fixed to the output shaft 9 at an axial distance from each other. Drive shaft 5 is provided with a helical groove 12. Two retaining rings 13 are arranged on the drive shaft 5 at an axial distance from each other. Furthermore, the gear mechanism 6 comprises a coupling unit 14, which comprises a third gear wheel 15 and a fourth gear wheel 16 and which has a lug 17. The coupling unit 14 is arranged to be axially moveable on the drive shaft 5 such that lug engages in the groove 12. The coupling unit 14 is arranged between the two retaining rings 13. A spring element 18 can be arranged between each retaining ring 13 and the coupling unit in each instance.

The rotation of the drive shaft 5 in the first direction of rotation moves the coupling unit 14 axially along the drive shaft 5, by means of its lug 17 engaged in the groove 12, into a first position area in which the third gear wheel 15 of the coupling unit 14 engages in the first gear wheel 10 of the output shaft 9. The rotation of the drive shaft 5 in a second direction of rotation, which is opposite to the first direction of rotation, moves the coupling unit 14 axially along the drive shaft 5 into a second position area in which the fourth gear wheel 16 of the coupling unit 14 engages in the second gear wheel 11 of the output shaft 9. By means of an appropriate configuration of the first gear wheel 10, the second gear wheel 11, the third gear wheel 15 and the fourth gear wheel 16, the gear mechanism 6 can provide a greater transmission ratio in the second position area than in the first position area. For this, the ratio of the number of teeth on the first gear wheel 10 to the number of teeth on the third wheel 15 is greater than the ratio of the number of teeth on the second gear wheel 11 to the number of teeth on the fourth gear wheel 16.

The first gear train 7 is formed by the drive shaft 5, the third gear wheel 15 of coupling unit 14, the first gear wheel 10 and the output shaft 9 when the coupling unit 14 is located in its first position area. The second gear train 8 is formed by the drive shaft 5, the fourth gear wheel 16 of the coupling unit 14, the second gear wheel 11 and the output shaft 9 when the coupling unit is located in its second position area.

FIG. 3 shows a second embodiment of the gear mechanism 6. The first gear wheel 10 and the second gear wheel 11 are arranged on the output shaft 9 at an axial distance from each other, but are not rotationally fixed thereon, so that the output shaft 9, the first gear wheel 10 and the second gear wheel 11 can each move independently of each other. The first gear wheel 10 has a first dog 19 and the second gear wheel 11 has a second dog 20. The first dog 19 and the second dog 20 are arranged facing each other on their respective gear wheel. Longitudinal toothing 21 is provided in output shaft 9. The coupling unit 14 is arranged to be axially movable along the longitudinal toothing 21 of the output shaft 9, such that the coupling unit 14 is rotationally coupled with the output shaft 9.

In the second embodiment of the gear mechanism 6, the coupling unit 14 has a third dog 22 instead of the third gear wheel 15, which faces the first dog 19 of the first gear wheel 10, and a fourth dog 23 instead of the fourth gear wheel 16, which faces the second dog 20 of the second gear wheel 11.

The coupling unit 14 can be moved axially into the first position area on the output shaft 9, where the third dog 22 of the coupling unit 14 engages in the first dog 19 of the first gear wheel 10. A fifth gear wheel 24 is fixed to the drive shaft 5, which engages in the first gear wheel 10. In the first position area, the first gear train 7 is formed by the drive shaft 5, the fifth gear wheel 24, the first gear wheel 10, the coupling unit 14 and the output shaft 9.

Furthermore, the coupling unit 14 can be moved axially into the second position area on the output shaft 9, where the fourth dog 23 of the coupling unit 14 engages in the second dog 20 of the second gear wheel 11. A sixth gear wheel 25 is arranged on the drive shaft 5, which engages in the second gear wheel 11. In the second position area, the second gear train 8 is formed by the drive shaft 5, the sixth gear wheel 25, the second gear wheel 11, the coupling unit 14 and the output shaft 9.

By means of an appropriate configuration of the first gear wheel 10, the second gear wheel 11, the fifth gear wheel 24 and the sixth gear wheel 25, the gear mechanism 6 can provide a greater transmission ratio in the second position area than in the first position area. For this, the ratio of the number of teeth on the first gear wheel 10 to the number of teeth on the fifth wheel 24 is greater than the ratio of the number of teeth on the second gear wheel 11 to the number of teeth on the sixth gear wheel 25.

The first and third dogs 19, 22 that are assigned to each other and/or the second and fourth dogs 20, 23 that are assigned to each other are, for example, constructed as toothing or as pins. If the coupling unit 14 moves into the first or second position area, the toothing or the pins, for example, then engage in each other, thus allowing the drive torque to be transferred. The first, second, third and forth dogs 19, 20, 22, 23 can however also be configured differently.

In the second embodiment of the gear mechanism 6, the movement of the coupling unit 14 into the first position area or into the second position area can be provided by an appropriately controlled additional actuating drive for example. Furthermore, the drive shaft 5 and the output shaft 9 can be coupled to each other by way of belts or chains, for example, instead of by way of the first gear wheel 10 and the fifth gear wheel 24, and by way of the second gear wheel 11 and the sixth gear wheel 25. For this, the first and the fifth gear wheels 10, 24 and/or the second and sixth gear wheels 11, 25 are to be appropriately configured as belt pulleys or as chain wheels for example. The first gear train 7 and/or the second gear train 8 can also comprise further gear speeds, e.g. with further gear wheels, belt pulleys and belts, or chain wheels and chains.

The gear mechanism 6 is generally configured such that the coupling unit 14 is either located in its first position area or in its second position area. There may also be at least one neutral area. In the at least one neutral area, the coupling unit 14 is decoupled from the first gear wheel 10 and the second gear wheel 11. The coupling unit 14 can be preferentially held in the at least one neutral area by the spring elements 18 for example, when the actuating drive 4 is not driving the drive shaft 5.

### REFERENCE NUMERALS

1 Brake system
2 Drive unit
3 Brake unit
4 Actuating drive
5 Drive shaft
6 Gear mechanism
7 First gear train
8 Second gear train
9 Output shaft
10 First gear wheel
11 Second gear wheel
12 Groove
13 Retaining ring
14 Coupling unit
15 Third gear wheel
16 Fourth gear wheel
17 Lug
18 Spring element
19 First dog
20 Second dog
21 Longitudinal toothing
22 Third dog
23 Fourth dog
24 Fifth gear wheel
25 Sixth gear wheel

What is claimed is:

1. A gear mechanism for a brake system, comprising:
a gear mechanism which can be coupled on the inlet side to an actuating drive of the brake system by way of a drive shaft and the drive shaft can be driven rotationally by the actuating drive and the gear mechanism can be coupled on the output side to a brake unit of the brake system by way of an output shaft and the brake unit comprises at least one brake or the gear mechanism comprises the drive shaft and/or the output shaft,
the gear mechanism comprises a first and second gear train with different transmission ratios and
the gear mechanism is configured is such a way that, in order to apply the brake, only the first gear train sand, in order to release the brake, only the second gear train of the gear mechanism transmits a drive torque of the actuating drive to the output shaft and the transmission ratio of the second gear train is greater than the transmission ratio of the first gear train.

2. The gear mechanism according to claim 1, wherein the gear mechanism is configured such that either the first gear train or the second gear train is selected depending on the direction of rotation of the drive shaft.

3. The gear mechanism according to claim 1, wherein the gear mechanism comprises a coupling unit that is arranged such that it can be moved into a first and into a second position area and that the drive shaft is coupled to output shaft by the coupling unit in the first and in the second position areas in such a way that coupling in the first position area forms the first gear train and coupling in the second position area forms the second gear train.

4. The gear mechanism according to claim 3, wherein a longitudinal toothing is provided in the drive shaft or the output shaft, and the coupling element is arranged so that it can be moved axially on the drive shaft or the output shaft into the first position area or the second position area, in such a way that the coupling element is rotationally coupled to the drive shaft or the output shaft by the longitudinal toothing.

5. The gear mechanism according to claim 3, wherein a helical groove is provided in the drive shaft, and the coupling unit has a lug, and the coupling unit is arranged so that it can be moved axially on the drive shaft in such a way that the lug engages in the groove, and the coupling unit is moved axially by the rotation of the drive shaft into the first position area or into the second position area depending on the direction of rotation.

6. The gear mechanism according to claim 3, wherein the coupling unit comprises at least one gear wheel or dog for the first gear train and the second gear train in each instance, which engages with a further gear wheel or dog that is assigned to the respective gear train in the first position area or in the second position area in order to transfer the drive torque.

7. A brake system which comprises a drive unit and a brake unit with at least one brake, the drive unit comprising
an actuating drive,
a drive shaft which is coupled to the actuating drive and by which it can be rotationally moved,
an output shaft that is coupled to the brake unit in such a way that the brake unit applies or releases the brake depending on the direction of rotation of the output shaft,
a gear mechanism which is coupled on an inlet side to the drive shaft and on an outlet side to the output shaft or which comprises the drive shaft and/or the output shaft wherein the gear mechanism comprises a first and second gear train with different transmission ratios and the gear mechanism is configured is such a way that, in order to apply the brake, only the first gear train and, in order to release the brake, only the second gear train of the gear mechanism transmits a drive torque of the actuating drive to the output shaft and the transmission ratio of the second gear train is greater than the transmission ratio of the first gear train.

8. The brake system according to claim 7, wherein the gear mechanism is configured such that either the first gear train or the second gear train is selected depending on the direction of rotation of the drive shaft.

9. The brake system according to claim 7, wherein the gear mechanism comprises a coupling unit that is arranged such that it can be moved into a first and into a second position area and that the drive shaft is coupled to output shaft by the coupling unit in the first and in the second position areas in such a way that coupling in the first position area forms the first gear train and coupling in the second position area forms the second gear train.

10. The brake system according to claim 9, wherein a longitudinal toothing is provided in the drive shaft or the output shaft, and the coupling element is arranged so that it can be moved axially on the drive shaft or the output shaft into the first position area or the second position area, in such a way that the coupling element is rotationally coupled to the drive shaft or the output shaft by the longitudinal toothing.

11. The brake system according to claim 9, wherein a helical groove is provided in the drive shaft, and the coupling unit has a lug, and the coupling unit is arranged so that it can be moved axially on the drive shaft in such a way that the lug engages in the groove, and the coupling unit is moved axially by the rotation of the drive shaft into the first position area or into the second position area depending on the direction of rotation.

12. The gear mechanism according to claim 9, wherein the coupling unit comprises at least one gear wheel or dog for the first gear train and the second gear train in each instance, which engages with a further gear wheel or dog that is assigned to the respective gear train in the first position area or in the second position area in order to transfer the drive torque.
